(19) United States
(12) Patent Application Publication
(10) Pub. No.: US 2020/0401961 A1
(43) Pub. Date: Dec. 24, 2020

(54) AUTOMATED ORGANIZATIONAL SECURITY SCORING SYSTEM

(71) Applicant: Recorded Future, Inc., Somerville, MA (US)

(72) Inventors: Staffan Truvé, Alingsås (SE); Bill Ladd, Watertown, MA (US)

(21) Appl. No.: 16/749,836

(22) Filed: Jan. 22, 2020

Related U.S. Application Data
(60) Provisional application No. 62/795,493, filed on Jan. 22, 2019.

(51) Int. Cl. G06Q 10/06; H04L 29/06

(52) U.S. Cl. CPC G06Q 10/0635; H04L 63/1433; G06Q 10/067

(57) ABSTRACT

Computer security systems and methods are disclosed. In one general aspect, a computer security monitoring method is disclosed that includes continuously gathering machine-readable facts relating to a number of topics and continuously deriving and storing risk profiles for a plurality of monitored entities based on at least some of the facts. This method also includes providing an ontology that associates a different subset of the monitored entities to each of a plurality of organizational entities possessing digital assets, aggregating the risk scores for the scored entities for each of the organizational entities based on the associations in the ontology to derive an aggregated risk score, and electronically reporting the aggregated risk score to an end user.

### CROSS-REFERENCE TO RELATED APPLICATION

This patent application claims priority to U.S. Provisional Application Ser. No. 62/795,493, filed Jan. 22, 2019, which is herein incorporated by reference.

### FIELD OF THE INVENTION

This invention relates to methods and apparatus for evaluating security and/or protecting systems on large computer networks, such as the internet.

### BACKGROUND OF THE INVENTION

Corporations and other entities employ third parties, including vendors and service providers, to outsource a variety of operational tasks. There are risks associated with working with these third parties, particularly where the third party interfaces with the entity's corporate network. Security ratings providers derive and sell security ratings to assist in evaluating these third-party risks. Despite the availability of these ratings and a variety of other security tools, securing a network remains a very difficult task that is often not completely successful.

### SUMMARY OF THE INVENTION

Several aspects of this invention are presented in this specification and its claims. Systems according to the invention can help network administrators to detect, understand, and meaningfully assess risks posed by interacting with organizational entities. By continuously aggregating risk scores for threats posed by organizations, these administrators can quickly learn of changes to these risk levels. And openly presenting the triggering conditions for the underlying rules that lead to the aggregated risk score can also allow system administrators to understand and address these risk levels.

In one general aspect, the invention features a computer security monitoring method that includes continuously gathering machine-readable facts relating to a number of topics and continuously deriving and storing risk profiles for a plurality of monitored entities based on at least some of the facts. The method also includes providing an ontology that associates a different subset of the monitored entities to each of a plurality of organizational entities possessing digital assets, aggregating the risk scores for the scored entities for each of the organizational entities based on the associations in the ontology to derive an aggregated risk score, and electronically reporting the aggregated risk score to an end user.

In preferred embodiments, the method can further include responding to user requests to explore the ontological relationships that led to the aggregated organizational risk score. The method can further include determining whether the aggregated organizational risk score meets a predetermined criteria, with the step of electronically reporting including electronically issuing an alert in response to the meeting of the predetermined criteria. The step of electronically reporting can include issuing a report that includes the aggregated organizational entity risk score. The step of issuing a report can include issuing a report that further includes a plurality of visual elements that visually summarize the ontological relationships that lead to the aggregated organizational entity risk score. The step of issuing a report can include issuing an interactive report that includes a plurality of controls that allow the user to explore the ontological relationships that lead to the aggregated organizational entity risk score. The step of issuing a report can include issuing an interactive report that includes a plurality of visual elements that visually summarize the ontological relationships that lead to the aggregated organizational entity risk score, with the visual elements being responsive to user actuation to allow the user to explore the ontological relationships that lead to the aggregated organizational entity risk score. The step of presenting visual elements can present the visual elements as a series of textual links that visually summarize the ontological relationships that lead to the aggregated organizational entity risk score, in which the links can be actuated to further explore the ontological relationships that lead to the aggregated organizational entity risk score. The method can further include continuously updating the ontological relationships using an ongoing ontology maintenance process. The ontological relationships can include relationships between different organizational entities. The ontological relationships can include relationships between organizational entities and their subsidiaries. The ontological relationships can include relationships between organizational entities and their contractors. The ontological relationships can include relationships between organizational entities and network identifiers. The ontological relationships can include relationships between organizational entities and types of technology. The ontological relationships can be expressed as a directed acyclic graph.

In another general aspect, the invention features a computer security monitoring system that includes a fact monitoring interface operative to continuously gather machine-readable facts relating to a number of topics, risk assessment logic responsive to the fact monitoring interface and operative to continuously derive and store risk profiles for a plurality of monitored entities based on at least some of the facts. The system also includes ontology storage operative to store an ontology that associates a different subset of the monitored entities to each of a plurality of organizational entities possessing digital assets, aggregation logic operative to aggregate the risk scores for the scored entities for each of the organizational entities based on the associations in the ontology to derive an aggregated risk score, and a reporting interface operative to electronically report the aggregated risk score to an end user.

In a further general aspect, the invention features a computer security monitoring system that includes means for continuously gathering machine-readable facts relating to a number of topics, and means for continuously deriving and storing risk profiles for a plurality of monitored entities based on at least some of the facts. The system also includes means for providing an ontology that associates a different subset of the monitored entities to each of a plurality of organizational entities possessing digital assets, means for aggregating the risk scores for the scored entities for each of the organizational entities based on the associations in the ontology to derive an aggregated risk score, and means for electronically reporting the aggregated risk score to an end user.

### BRIEF DESCRIPTION OF THE DRAWING

FIG. 1 is a block diagram of an illustrative organizational security scoring subsystem according to the invention;

FIG. 2 is a block diagram of an illustrative threat scoring system that includes the organizational security scoring subsystem of FIG. 1;

FIG. 3 is an illustrative organizational entity ontology graph for the organizational security scoring subsystem of FIG. 1; and

FIG. 4 is a screenshot of an illustrative interactive threat report form for the organizational security scoring subsystem of FIG. 1.

### DETAILED DESCRIPTION OF AN ILLUSTRATIVE EMBODIMENT

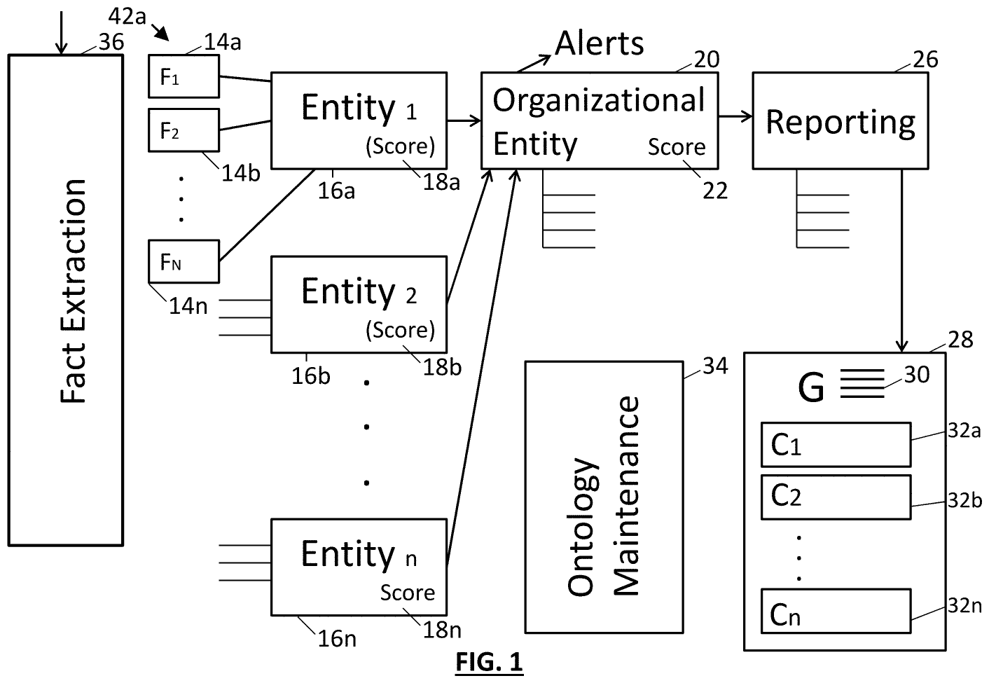

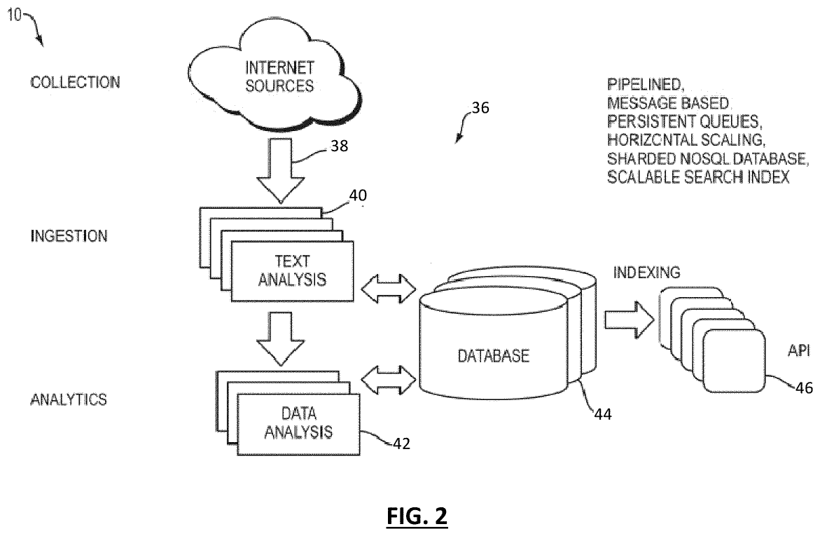

Referring to FIGS. 1 and 2, an organizational threat scoring system 10 includes a fact extraction subsystem 36 that collects and ingests information items about a wide variety of topics from a wide variety of sources. An important source of information is textual information posted on parts of the internet, such as the web, but other sources, such as paid third-party information sources, can also be included. The collected information items can be continuously processed to obtain a series of facts, such by text analysis agents. The extraction process is preferably performed by the Recorded Future Temporal Analytics Engine, which is described in more detail in U.S. Pat. No. 8,468,153 entitled INFORMATION SERVICE FOR FACTS EXTRACTED FROM DIFFERING SOURCES ON A WIDE AREA NETWORK and in U.S. Publication No. 20180063170 entitled NETWORK SECURITY SCORING. These two patent documents are both herein incorporated by reference.

As shown in FIG. 2, the fact extraction subsystem 36 includes a collection subsystem 38 and a text analysis subsystem 40. The text analysis subsystem extracts meaning information from the collected textual information, such as by applying natural language processing techniques. This extracted meaning information is stored as a series of facts 14a, 14b, . . . 14n, such as in a database 44.

A data analysis subsystem 42 analyzes items from the extracted meaning information to determine whether there are risks associated with them. When one or more risks are detected for a particular fact, the data analysis subsystem can associate corresponding risk identifiers with that fact. Risk identifiers can be of different types for different types of risks, and they can assigned in any suitable way. In one example, an IP address can be flagged with one type of risk identifier if it is associated with a Tor network. And a company web site that runs commonly exploited technology or older technology linked to specific exploits can be flagged with another type of risk identifier. An indexing subsystem organizes the threat information that it stores, so that it can also be accessed by one or more application programming interfaces 46 (APIs).

As shown in FIG. 1, the data analysis system 42 also includes an organizational scoring subsystem 42a. This subsystem aggregates the risk identifiers from the facts for different monitored entities 16a, 16b, . . . 16n based on the extracted facts 14a, 14b, . . . 14n that are relevant to that monitored entity. These aggregated risk identifiers can be stored as threat profiles that reflect the underlying pattern of risk identifiers, although they can also be stored as threat scores 18a, 18b, . . . 18n in some cases. The aggregated monitored entity threat identifiers and/or scores that are associated with an organizational entity 20 are then aggregated again to derive an organizational threat score 22.

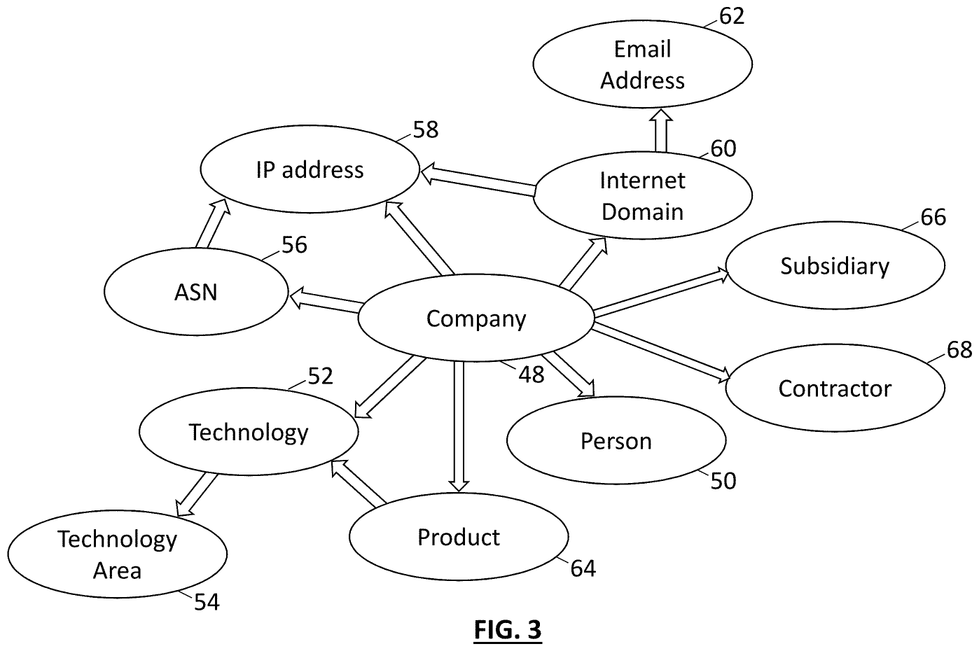

Referring also to FIG. 3, an organizational entity 20, such as a company 48 can be associated with a variety of different types of relevant monitored entities 16a, 16b, . . . 16n, such as, for example, one or more persons 50, technologies 52, Autonomous System Numbers (ADNs) 56, IP addresses 58, Internet domains 60, email addresses 62, products 64, subsidiaries 66, and/or contractors 68. Many other types of entries can be monitored, and the list can be changed as circumstances change. The risk identifiers for the monitored entities can change as new facts are extracted, and these changes will affect the organizational entity score 20.

If the score is changed in a way that causes it to meet one or more predetermined criteria, the system can generate a real-time alert, such as by sending an e-mail message. In one embodiment, any change for the worse is reported to the user with an alert, but other suitable criteria can also be used, such as when the score reaches an absolute threshold number, or when the magnitude of a change exceeds a predetermined amount.

The organizational scoring subsystem 42a can in addition include a reporting subsystem 26 that can report the aggregated score in a variety of machine-readable and user-readable formats. In one embodiment, it can present a user interface 28 with a score display area 30 and a list of ontology rule conditions 32a, 32b, . . . 32n, that led to the score. This can allow the user to quickly understand what the underlying rationale is for the score.

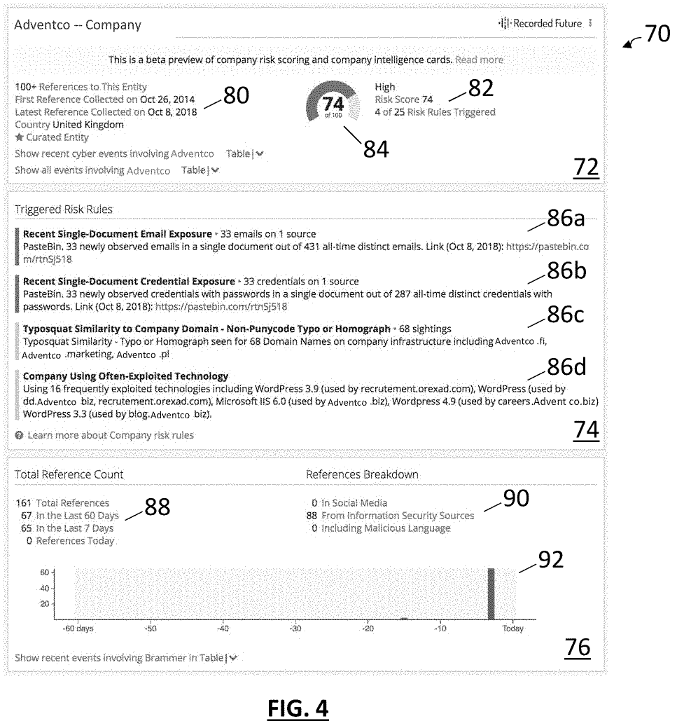

Referring also to FIG. 4, the reporting subsystem 26 can also present an interactive report form 70. This illustrative form presents a top-level summary box with background information 80 about the score, a risk rule count 82, and the score 84 itself to provide an easy first assessment. It also presents a triggered risk rule list box 74, and a reference box 76 that includes a reference count table 88, a references breakdown list 90, and a timeline 92, to provide more context.

This form is interactive at least in that the rule list entries can be actuated to learn more about them. Each rule list entry includes a title and a list of conditions that triggered the rule, which can include a condensed list of illustrative underlying risk identifiers. This conditional list can be made up of links that allow the user to drill into pages for additional information about the condition. This additional information can include a full listing of the risk identifiers for the underlying facts and metadata for each one, such as whois and history of registration information for IP addresses. In one embodiment, the form is implemented with javascript, but it can be implemented in a variety of different ways, including any dynamic web page definition system.

The interactive report form 70 can also lead a user to information about remediating the risks flagged on the form. This information can include suggestions about actions the user can take. It can also include controls that allow information about the risk to be sent to a third party organization, such as a takedown service.

The organizational scoring subsystem 42a can provide an ontology that implements any suitable relationship between the organizational entities, monitored entities, and facts. Organizational entities can also depend on each other, such as in a parent-subsidiary or company-contractor relationship. In one embodiment, the ontological relationships can be expressed as a directed acyclic graph.

The organizational scoring subsystem 42a can weigh the relationships within the ontology in a variety of ways. It can simply aggregate threat information, such as by using a weighted average. Or it can use a more sophisticated approach, such as a rule set that can express more complex relationships. This can allow the importance of certain types of threats to be gated based on the presence of others, for example. The relationships are specific to particular situations and technologies and it is expected that they may have to be adjusted over time in an ontology maintenance process. In one embodiment, the score is computed as follows:

$$Score = min ( B {min}_{\text{?}} + 5 * ( {\sum }_{\text{?} = \text{?}}^{\text{?}} {I}_{\text{?} , \text{?}} - \text{?} ) + {\sum }_{c = 1}^{\text{?} = 1} {\sum }_{\text{?} = 1}^{\text{?}} {I}_{\text{?} \text{?}} B {max}_{\text{?}} ) \\ \text{?} \text{indicates text missing or illegible when filed}$$

C is the number of risk categories, c is a specific category in (1, . . . , C)

R_{c} is the number of rules in categor c, r_{c,i} is a specific rule in (1, . . . , R_{c})

$${c}_{m ax} = max ( c ) where {\sum }_{{c}_{\text{?}} = c + 1}^{c} {\sum }_{r = 1}^{{r}_{c}} {I}_{r , {c}_{\text{?}} } = 0$$

$$\text{?} \text{indicates text missing or illegible when filed}$$

Iᵣ=1 if ruler r in category c applies to company

I_{r,c}=0 if rule r in category c does not apply to company

The system described above has been implemented in connection with digital logic, storage, and other elements embodied in special-purpose software running on a general-purpose computer platform, but it could also be implemented in whole or in part using special-purpose hardware. And while the system can be broken into the series of modules and steps shown in the various figures for illustration purposes, one of ordinary skill in the art would recognize that it is also possible to combine them and/or split them differently to achieve a different breakdown.

The embodiments presented above can benefit from temporal and linguistic processing and risk scoring approaches outlined in U.S. Ser. No. 61/620,393, entitled INTERACTIVE EVENT-BASED INFORMATION SYSTEM, filed Apr. 4, 2012; U.S. Publication Nos. 20100299324 and 20090132582 both entitled INFORMATION SERVICE FOR FACTS EXTRACTED FROM DIFFERING SOURCES ON A WIDE AREA NETWORK; as well as to U.S. Ser. No. 61/550,371 entitled SEARCH ACTIVITY PREDICTION; and to U.S. Ser. No. 61/563,528 entitled AUTOMATED PREDICTIVE SCORING IN EVENT COLLECTION, which are all herein incorporated by reference.

The present invention has now been described in connection with a number of specific embodiments thereof. However, numerous modifications which are contemplated as falling within the scope of the present invention should now be apparent to those skilled in the art. Therefore, it is intended that the scope of the present invention be limited only by the scope of the claims appended hereto. In addition, the order of presentation of the claims should not be construed to limit the scope of any particular term in the claims.

What is claimed is:

1. A computer security monitoring method, including:
continuously gathering machine-readable facts relating to a number of topics,
continuously deriving and storing risk profiles for a plurality of monitored entities based on at least some of the facts,
providing an ontology that associates a different subset of the monitored entities to each of a plurality of organizational entities possessing digital assets,
aggregating the risk scores for the scored entities for each of the organizational entities based on the associations in the ontology to derive an aggregated risk score, and
electronically reporting the aggregated risk score to an end user.

2. The method of claim 1 further including responding to user requests to explore the ontological relationships that led to the aggregated organizational risk score.

3. The method of claim 1 further including the step of determining whether the aggregated organizational risk score meets a predetermined criteria, and wherein the step of electronically reporting includes electronically issuing an alert in response to the meeting of the predetermined criteria.

4. The method of claim 1 wherein the step of electronically reporting includes issuing a report that includes the aggregated organizational entity risk score.

5. The method of claim 4 wherein the step of issuing a report includes issuing a report that further includes a plurality of visual elements that visually summarize the ontological relationships that lead to the aggregated organizational entity risk score.

6. The method of claim 4 wherein the step of issuing a report includes issuing an interactive report that includes a plurality of controls that allow the user to explore the ontological relationships that lead to the aggregated organizational entity risk score.

7. The method of claim 4 wherein the step of issuing a report includes issuing an interactive report that includes a plurality of visual elements that visually summarize the ontological relationships that lead to the aggregated organizational entity risk score, and wherein the visual elements are responsive to user actuation to allow the user to explore the ontological relationships that lead to the aggregated organizational entity risk score.

8. The method of claim 7 wherein the step of presenting visual elements presents the visual elements as a series of textual links that visually summarize the ontological relationships that lead to the aggregated organizational entity risk score, and wherein the links can be actuated to further explore the ontological relationships that lead to the aggregated organizational entity risk score.

9. The method of claim 1 further including continuously updating the ontological relationships using an ongoing ontology maintenance process.

10. The method of claim 1 wherein the ontological relationships include relationships between different organizational entities.

11. The method of claim 10 wherein the ontological relationships include relationships between organizational entities and their subsidiaries.

12. The method of claim 10 wherein the ontological relationships include relationships between organizational entities and their contractors.

13. The method of claim 1 wherein the ontological relationships include relationships between organizational entities and network identifiers.

14. The method of claim 1 wherein the ontological relationships include relationships between organizational entities and types of technology.

15. The method of claim 1 wherein the ontological relationships can be expressed as a directed acyclic graph.

16. A computer security monitoring system, including:
a fact monitoring interface operative to continuously gather machine-readable facts relating to a number of topics,
risk assessment logic responsive to the fact monitoring interface and operative to continuously derive and store risk profiles for a plurality of monitored entities based on at least some of the facts,
ontology storage operative to store an ontology that associates a different subset of the monitored entities to each of a plurality of organizational entities possessing digital assets,
aggregation logic operative to aggregate the risk scores for the scored entities for each of the organizational entities based on the associations in the ontology to derive an aggregated risk score, and
a reporting interface operative to electronically report the aggregated risk score to an end user.

17. A computer security monitoring system, including:
means for continuously gathering machine-readable facts relating to a number of topics,
means for continuously deriving and storing risk profiles for a plurality of monitored entities based on at least some of the facts,
means for providing an ontology that associates a different subset of the monitored entities to each of a plurality of organizational entities possessing digital assets,
means for aggregating the risk scores for the scored entities for each of the organizational entities based on the associations in the ontology to derive an aggregated risk score, and
means for electronically reporting the aggregated risk score to an end user.
